(19) United States
(12) Patent Application Publication
(10) Pub. No.: US 2024/0292436 A1
(43) Pub. Date: Aug. 29, 2024

(54) METHODS FOR PRIORITIZING INTER-USER EQUIPMENT (UE) COORDINATION

(71) Applicant: QUALCOMM Incorporated, San Diego, CA (US)

(72) Inventors: Shuanshuan WU, San Diego, CA (US); Tien Viet NGUYEN, Bridgewater, NJ (US); Gabi SARKIS, San Diego, CA (US); Sourjya DUTTA, San Diego, CA (US); Hui GUO, Beijing (CN); Kapil GULATI, Belle Mead, NJ (US)

(21) Appl. No.: 18/569,076

(22) PCT Filed: Aug. 11, 2021
(86) PCT No.: PCT/CN2021/112013

§ 371 Date: Dec. 11, 2023

(51) Int. Cl. H04W 72/40; H04W 72/56

(52) U.S. Cl. CPC H04W 72/40; H04W 72/56

(57) ABSTRACT

Certain aspects of the present disclosure provide a method for wireless communication by a first user equipment (UE). The first UE selects one or more inter-UE coordination information messages based on at least one prioritization rule. The first UE then transmits the selected one or more inter-UE coordination information messages to at least a second UE via a sidelink.

### BACKGROUND

### Field of the Disclosure

Aspects of the present disclosure relate to wireless communications, and more particularly, to techniques for prioritizing inter-user equipment (UE) coordination.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd generation partnership project (3GPP) long term evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New Radio (NR) (e.g., 5th generation (5G)) is an example of an emerging telecommunication standard. NR is a set of enhancements to the LTE mobile standard promulgated by 3GPP. It is designed to better support mobile broadband Internet access by improving spectral efficiency, lowering costs, improving services, making use of new spectrum, and better integrating with other open standards using OFDMA with a cyclic prefix (CP) on a downlink (DL) and on an uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide advantages that include improved and desirable techniques for prioritizing inter-user equipment (UE) coordination.

Certain aspects of the subject matter described in this disclosure can be implemented in a method for wireless communications by a first UE. The method generally includes selecting one or more inter-UE coordination information messages based on at least one prioritization rule and transmitting the selected one or more inter-UE coordination information messages to at least a second UE via a sidelink.

Certain aspects of the subject matter described in this disclosure can be implemented in an apparatus for wireless communications by a first UE. The apparatus generally includes at least one application processor and a memory configured to: select one or more inter-UE coordination information messages based on at least one prioritization rule and transmit the selected one or more inter-UE coordination information messages to at least a second UE via a sidelink.

Certain aspects of the subject matter described in this disclosure can be implemented in an apparatus for wireless communications by a first UE. The apparatus generally includes means for selecting one or more inter-UE coordination information messages based on at least one prioritization rule and means for transmitting the selected one or more inter-UE coordination information messages to at least a second UE via a sidelink.

Certain aspects of the subject matter described in this disclosure can be implemented in a computer readable medium storing computer executable code thereon for wireless communications by a first UE. The computer readable medium generally includes code for selecting one or more inter-UE coordination information messages based on at least one prioritization rule and code for transmitting the selected one or more inter-UE coordination information messages to at least a second UE via a sidelink.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain aspects of this disclosure and the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example base station (BS) and a user equipment (UE), in accordance with certain aspects of the present disclosure.

FIG. 3 is an example frame format for certain wireless communication systems (e.g., a new radio (NR)), in accordance with certain aspects of the present disclosure.

FIGS. 4A and 4B show diagrammatic representations of example vehicle to everything (V2X) systems, in accordance with certain aspects of the present disclosure.

FIG. 5 illustrates example allocation of a resource pool for sidelink communications, in accordance with certain aspects of the present disclosure.

FIG. 6 illustrates example resource pool for sidelink communications, in accordance with certain aspects of the present disclosure.

FIG. 7 illustrates example modes of sidelink communications, in accordance with certain aspects of the present disclosure.

FIG. 8 illustrates example timeline of future resource allocations for sidelink communications, in accordance with certain aspects of the present disclosure.

FIGS. 9A-9B illustrate example deployments of sidelink communications, in accordance with certain aspects of the present disclosure.

FIG. 10 illustrates example deployment of sidelink communications, in accordance with certain aspects of the present disclosure.

FIG. 11 illustrates example coordination information sharing between sidelink UEs, in accordance with certain aspects of the present disclosure.

FIG. 12 is a flow diagram illustrating example operations for wireless communications by a UE, in accordance with certain aspects of the present disclosure.

FIG. 13 is a call flow diagram illustrating example signaling for prioritizing inter-UE coordination, in accordance with certain aspects of the present disclosure.

FIG. 14 illustrates a communications device that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide techniques for prioritizing inter-user equipment (UE) coordination. For example, a UE may prioritize selection and transmission of inter-UE coordination messages based on a cast type (or a hybrid automatic repeat request (HARQ) feedback type), whether the UE is an intended receiver of another UE, and/or a type of an inter-UE coordination message.

The following description provides examples of inter-UE coordination operations in wireless communication systems. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3rd generation (3G), 4G, and/or new radio (e.g., 5G new radio (NR)) wireless technologies, aspects of the present disclosure can be applied in other generation-based communication systems.

NR access may support various wireless communication services, such as enhanced mobile broadband (eMBB) targeting wide bandwidth, millimeter wave mmW, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QOS) requirements. In addition, these services may co-exist in the same subframe.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

### Example Wireless Communications System

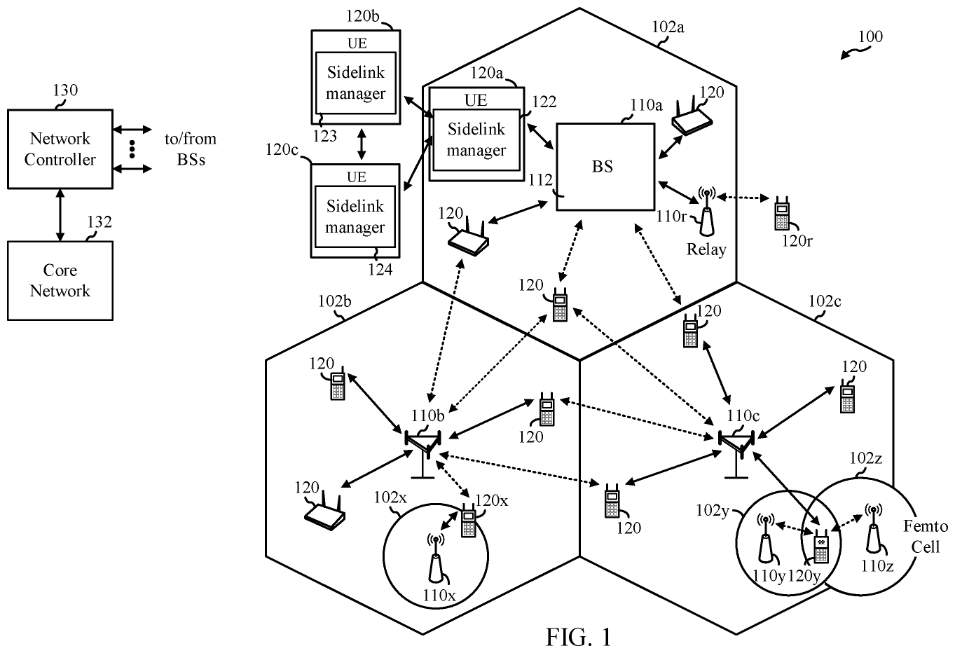

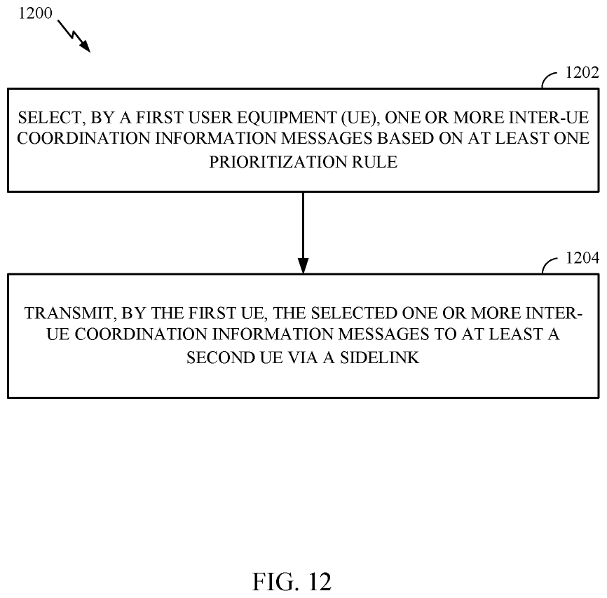

FIG. 1 illustrates an example wireless communication network 100 in which aspects of the present disclosure may be performed. For example, according to certain aspects, the wireless communication network 100 may include base stations (BSs) 110 and/or user equipments (UEs) 120. As shown in FIG. 1, the UEs 120 may include UE 120a, UE 120b, and UE 120c, which may perform sidelink communications. The UE 120a includes a sidelink manager 122, which may be configured to perform operations 1200 of FIG. 12. The UE 120b includes a sidelink manager 123, which may be configured to perform operations 1200 of FIG. 12. The UE 120c includes a sidelink manager 124, which may be configured to perform operations 1200 of FIG. 12.

The wireless communication network 100 may be a NR system (e.g., a 5th generation (5G) NR network). As shown in FIG. 1, the wireless communication network 100 may be in communication with a core network. The core network may in communication with BSs 110a-z (each also individually referred to herein as a BS 110 or collectively as BSs 110) and/or UEs 120a-y (each also individually referred to herein as a UE 120 or collectively as UEs 120) in the wireless communication network 100 via one or more interfaces.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS 110 may support one or multiple cells.

The BSs 110 communicate with UEs 120 in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

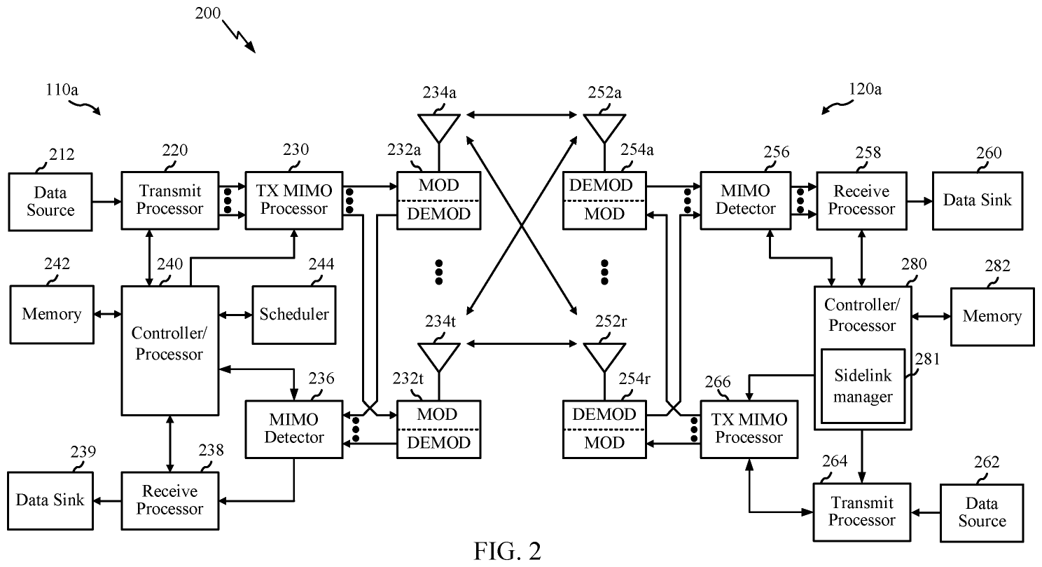

FIG. 2 illustrates example components of a BS 110a and a UE 120a (e.g., in the wireless communication network 100 of FIG. 1).

At the BS 110a, a transmit processor 220 may receive data from a data source 212 and control information from a controller/processor 240. The control information may be for a physical broadcast channel (PBCH), a physical control format indicator channel (PCFICH), a physical hybrid ARQ (automatic repeat request) indicator channel (PHICH), a physical downlink control channel (PDCCH), a group common PDCCH (GC PDCCH), etc. The data may be for a physical downlink shared channel (PDSCH), etc. A medium access control-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The transmit processor 220 may process (e.g., encode and symbol map) the data and control information to obtain data symbols and control symbols, respectively. The transmit processor 220 may also generate reference symbols, such as for a primary synchronization signal (PSS), a secondary synchronization signal (SSS), and a channel state information reference signal (CSI-RS). A transmit multiple-input multiple-output (MIMO) processor 230 may perform spatial processing (e.g., precoding) on the data symbols, the control symbols, and/or the reference symbols, if applicable, and may provide output symbol streams to modulators (MODs) in transceivers 232a-232t. Each MOD in transceivers 232a-232t may process a respective output symbol stream (e.g., for orthogonal frequency division multiplexing (OFDM), etc.) to obtain an output sample stream. Each MOD in transceivers 232a-232t may further process (e.g., convert to analog, amplify, filter, and upconvert) the output sample stream to obtain a downlink (DL) signal. The DL signals from the MODs in transceivers 232a-232t may be transmitted via antennas 234a-234t, respectively.

At the UE 120a, antennas 252a-252r may receive DL signals from the BS 110a and may provide received signals to demodulators (DEMODs) in transceivers 254a-254r, respectively. Each DEMOD in the transceiver 254 may condition (e.g., filter, amplify, downconvert, and digitize) a respective received signal to obtain input samples. Each DEMOD in the transceiver 254 may further process the input samples (e.g., for OFDM, etc.) to obtain received symbols. A MIMO detector 256 may obtain received symbols from all the DEMODs in the transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On an uplink (UL), at the UE 120a, a transmit processor 264 may receive and process data (e.g., for a PUSCH) from a data source 262 and control information (e.g., for a physical uplink control channel (PUCCH) from the controller/processor 280. The transmit processor 264 may also generate reference symbols for a reference signal (e.g., for a sounding reference signal (SRS)). The symbols from the transmit processor 264 may be precoded by a transmit MIMO processor 266 if applicable, further processed by the MODs in transceivers 254a-254r (e.g., for SC-FDM, etc.), and transmitted to the BS 110a. At the BS 110a, the UL signals from the UE 120a may be received by the antennas 234, processed by the DEMODs in transceivers 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

Memories 242 and 282 may store data and program codes for the BS 110a and the UE 120a, respectively. A scheduler 244 may schedule the UE 120a for data transmission on a DL and/or an UL.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 280 of the UE 120a has a sidelink manager 281 that may be configured to perform the operations illustrated in FIG. 12, as well as other operations disclosed herein. Although shown at the controller/processor, other components of the UE 120a and the BS 110a may be used to perform the operations described herein.

NR may utilize OFDM with a cyclic prefix (CP) on the UL and the DL. The NR may support half-duplex operation using time division duplexing (TDD). The OFDM and single-carrier frequency division multiplexing (SC-FDM) partition system bandwidth into multiple orthogonal subcarriers, which are also commonly referred to as tones, bins, etc. Each subcarrier may be modulated with data. Modulation symbols may be sent in a frequency domain with the OFDM and in a time domain with the SC-FDM. The spacing between adjacent subcarriers may be fixed, and a total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. The NR may support a base subcarrier spacing (SCS) of 15 KHz and other SCS may be defined with respect to the base SCS (e.g., 30 kHz, 60 kHz, 120 kHz, 240 kHz, etc.).

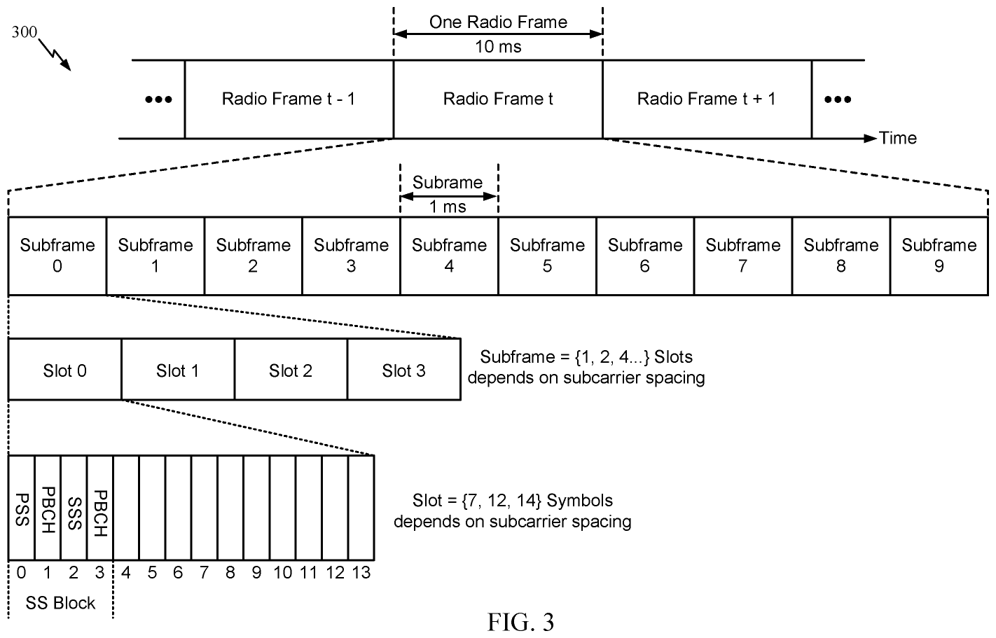

FIG. 3 is a diagram showing an example of a frame format 300 for NR. A transmission timeline for each of DL and UL may be partitioned into units of radio frames. Each radio frame may have a predetermined duration (e.g., 10 ms), and may be partitioned into 10 subframes, each of 1 ms, with indices of 0 through 9. Each subframe may include a variable number of slots (e.g., 1, 2, 4, 8, 16, . . . slots) depending on a SCS. Each slot may include a variable number of symbol periods (e.g., 7, 12, or 14 symbols) depending on the SCS. Symbol periods in each slot may be assigned indices. A sub-slot structure may refer to a transmit time interval having a duration less than a slot (e.g., 2, 3, or 4 symbols). Each symbol in a slot may be configured for a link direction (e.g., a DL, an UL, or a flexible) for data transmission, and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and the SSS may be used by UEs for cell search and acquisition. The PSS may provide half-frame timing, a synchronization signal (SS) may provide a CP length and frame timing. The PSS and the SSS may provide cell identity. The PBCH carries some basic system information, such as DL system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a PDSCH in certain subframes. The SSB can be transmitted up to sixty-four times, for example, with up to sixty-four different beam directions for mmWave. The multiple transmissions of the SSB are referred to as a SS burst set. The SSBs in an SS burst set may be transmitted in the same frequency region, while the SSBs in different SS bursts sets can be transmitted at different frequency regions.

### Example Sidelink Communications

Communication between wireless nodes (such as a user equipment (UE) and a base station (BS)) may be referred to as an access link. Communication between multiple UEs may be referred as sidelink. Real-world applications of sidelink communications may include vehicle-to-vehicle (V2V) communications, internet of everything (IoE) communications, etc.

UEs may communicate with each other using sidelink signals. A sidelink signal may refer to a signal communicated from one UE (for example, a transmitter UE) to another UE (for example, a receiver UE) without relaying that communication through the BS, even though the BS may be utilized for scheduling and/or control purposes. The sidelink signals may be communicated using a licensed spectrum (unlike wireless local area networks that may use an unlicensed spectrum). One example of sidelink communication is PC5 as used in V2V communications.

Sidelink channels may be used for sidelink communications. The sidelink channels may include a physical sidelink discovery channel (PSDCH), a physical sidelink control channel (PSCCH), a physical sidelink shared channel (PSSCH), and/or a physical sidelink feedback channel (PSFCH). The PSDCH may carry discovery expressions, which may enable proximal UEs to discover each other. The PSCCH may carry control signaling such as sidelink resource configurations and other parameters used for data transmissions. The PSSCH may carry data transmissions. The PSFCH may carry feedback such as channel state information (CSI) related to a sidelink channel quality.

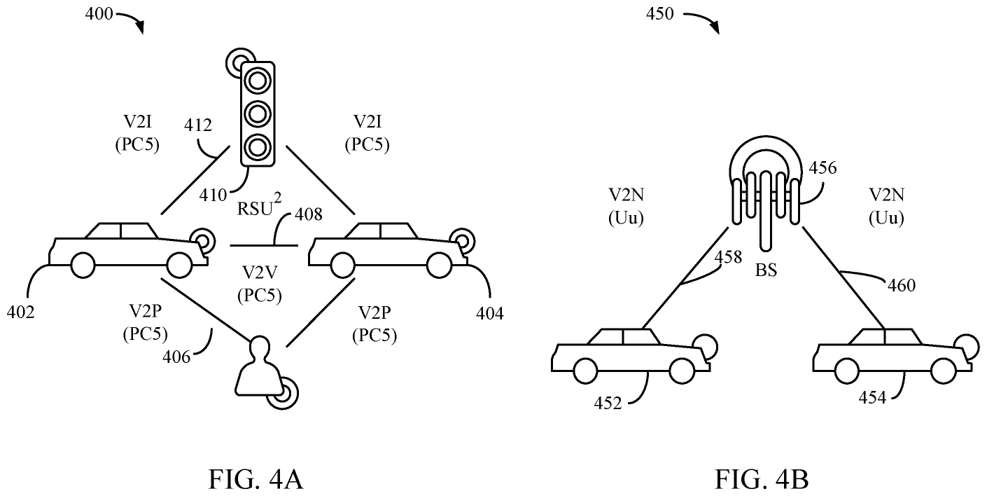

FIG. 4A and FIG. 4B show diagrammatic representations of example vehicle to everything (V2X) systems. Vehicles shown in these V2X systems may communicate via sidelink channels.

The V2X systems in FIG. 4A and FIG. 4B provide two complementary transmission modes. A first transmission mode, shown by way of example in FIG. 4A, involves direct communications (e.g., referred to as sidelink communications) between vehicles in proximity to one another in a local area. A second transmission mode, shown by way of example in FIG. 4B, involves network communications through a network, which may be implemented over a Uu interface (e.g., a wireless communication interface between a radio access network (RAN) and a vehicle).

Referring to FIG. 4A, a V2X system 400 (including vehicle to vehicle (V2V) communications) is illustrated with two vehicles 402, 404. The first transmission mode allows for direct communication between different participants in a given geographic location. As illustrated, a vehicle can have a wireless communication link 406 with an individual (V2P) (for example, via a UE) through a PC5 interface. Communications between the vehicles 402 and 404 may also occur through a PC5 interface 408. In a like manner, communication may occur from a vehicle 402 to other highway components (for example, a highway component 410), such as a traffic signal or sign (vehicle-to-infrastructure (V2I)) through a PC5 interface 412. With respect to each communication link illustrated in FIG. 4A, two-way communication may take place between elements, therefore each element may be a transmitter and a receiver of information. The V2X system 400 may be a self-managed system implemented without assistance from a network entity. A self-managed system may enable improved spectral efficiency, reduced cost, and increased reliability as network service interruptions do not occur during handover operations for moving vehicles. The V2X system 400 may be configured to operate in a licensed or unlicensed spectrum, thus any vehicle with an equipped system may access a common frequency and share information. Such harmonized/common spectrum operations allow for safe and reliable operation.

FIG. 4B shows a V2X system 450 for communication between a vehicle 452 and a vehicle 454 through a network entity 456. These network communications may occur through discrete nodes, such as the network entity 456 (e.g., such as the BS 110a of FIG. 1 or FIG. 2), that sends and receives information to and from (for example, relays information between) the vehicles 452, 454. The network communications through vehicle to network (V2N) links 458 and 460 may be used, for example, for long range communications between the vehicles 452, 454, such as for communicating the presence of a car accident a distance ahead along a road or highway. Other types of communications may be sent by the network entity 456 to the vehicles 452, 454, such as traffic flow conditions, road hazard warnings, environmental/weather reports, and service station availability, among other examples. Such data can be obtained from cloud-based sharing services.

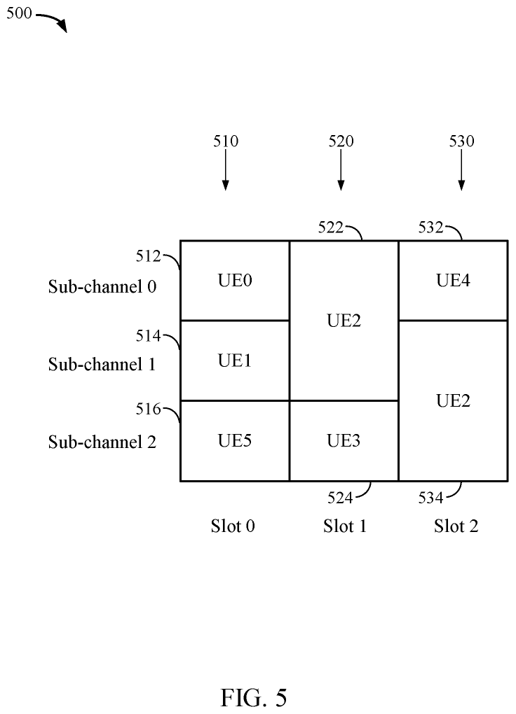

FIG. 5 is an example of how resources of a common resource pool 500 may be allocated for sidelink communications (broadcast and groupcast device-to-device (D2D)) between UEs (e.g., UEs 120 shown in FIG. 1). As noted above, sidelink refers to a link between two users, or user-relays that can be used in different scenarios and for different applications. As previously described, when a UE is transmitting a sidelink communication on a sub-channel of a frequency band, the UE is unable to receive another communication (e.g., another sidelink communication from another UE) in the frequency band. Accordingly, the sidelink communications may be referred to as being half-duplex.

As illustrated in FIG. 5, UEs 0, 1, and 5, which transmit sidelink transmissions 512, 514, and 516 respectively, cannot receive the sidelink transmissions from each other. That is, UE 0 cannot receive the sidelink transmissions 514 and 516. Similarly, UE 2 cannot receive the sidelink transmissions 524 and 532 from UEs 3 and 4, respectively. Also, UE 3 cannot receive sidelink transmission 522 from UE 2, and UE 4 cannot receive the sidelink transmission 534 from UE 2. In aspects of the present disclosure, a sidelink transmission(s) that cannot be received may be referred to as being “erased” for the UE or wireless node that cannot receive the sidelink transmission, because the UE has no information regarding that sidelink transmission. This is unlike other situations in which the UE fails to decode a transmission, because in those situations, the UE may retain some information regarding the transmission that the UE failed to decode, and the UE may combine that retained information with a retransmission that the UE receives to determine the transmission that the UE failed to decode.

According to previously known techniques, resource allocation is reservation based in new radio (NR) sidelink communications. In these techniques, resource allocations are made in units of sub-channels in a frequency domain and are limited to one slot in a time domain. In the previously known techniques, a transmission may reserve resources in a current slot and in up to two future slots. Reservation information may be carried in sidelink control information (SCI). In the previously known techniques, the SCI may be transmitted in two stages. A first stage SCI (SCI-1) may be transmitted on a PSCCH and contains resource reservation information as well as information needed to decode a second stage SCI (SCI-2). A SCI-2 may be transmitted on the PSSCH and contains information needed to decode data on the shared channel and to provide feedback (e.g., acknowledgments (ACKs) or negative acknowledgments (NAKs)) over a PSFCH.

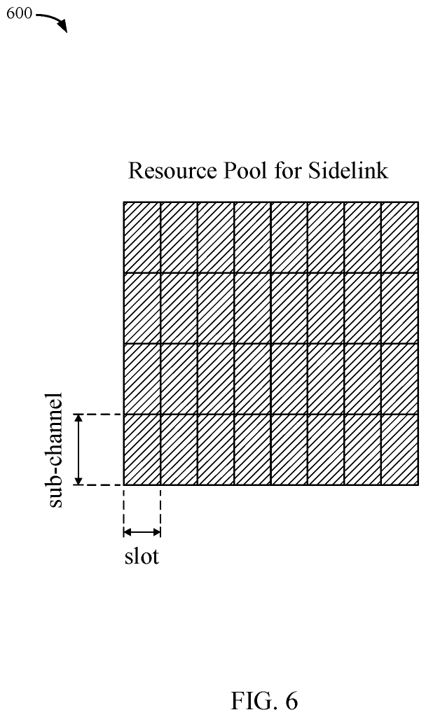

FIG. 6 is an example resource pool 600 for sidelink communications. As illustrated, a minimum resource allocation unit is a sub-channel in a frequency domain (i.e., as shown in y axis) and a resource allocation in a time domain is a slot (i.e., as shown in x axis). For example, depending on subcarrier spacing (SCS) values, and depending on whether a normal cyclic prefix (CP) or an extended CP is used, a slot in the time domain may include 12 or 14 orthogonal frequency division multiplexing (OFDM) symbols.

In the frequency domain, each subchannel may include a set number of consecutive resource blocks (RBs), which may include 12 consecutive subcarriers with the same SCS, such as 10, 15, 20, 25 . . . etc. consecutive RBs depending on practical configuration. Hereinafter, each unit of resource in one slot and in one subchannel is referred to as a resource, or resource unit. For a certain resource pool, the resources therein may be referred to using the coordinates of a slot index (e.g., the n^{th} slot in the x axis of the time domain) and a subchannel index (e.g., the m^{th} subchannel in the y axis of the frequency domain). Interchangeably, the slot index may be referred to as a time index; and the subchannel index may be referred to as a frequency index.

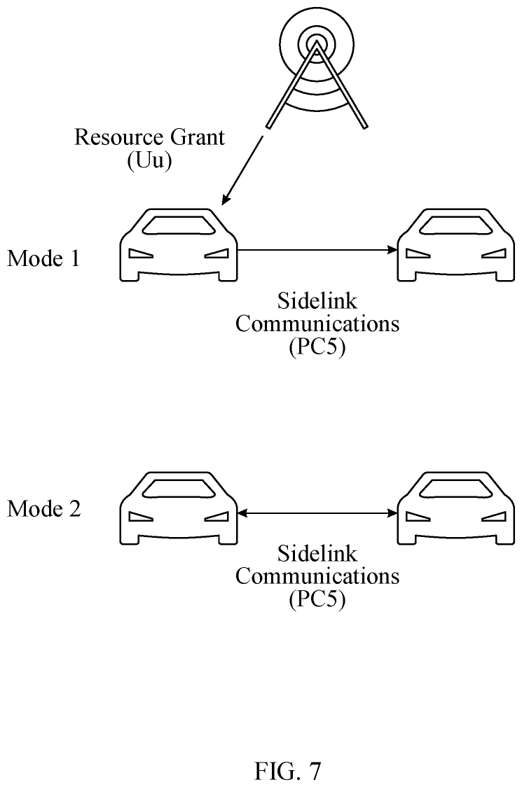

FIG. 7 illustrates two modes (e.g., Mode 1 and Mode 2) of resource allocation for sidelink communications. In Mode 1 sidelink communication, sidelink resources are often scheduled by a gNodeB (gNB). In Mode 2 sidelink communication, a UE may autonomously select sidelink resources from a (pre)configured sidelink resource pool(s) based on a channel sensing mechanism. When the UE is in-coverage, the gNB may be configured to adopt Mode 1 or Mode 2. When the UE is out of coverage, only Mode 2 may be adopted.

In Mode 2, when traffic arrives at a transmitting UE, the transmitting UE may select resources for PSCCH and PSSCH, and/or reserve resources for retransmissions to minimize latency. Therefore, in conventional configurations, the transmitting UE would select resources for the PSSCH associated with the PSCCH for an initial transmission and blind retransmissions, which incurs unnecessary resources and related power consumption. To avoid such resource waste and other similar resource duplication/blind reservation/redundancy, UEs in sidelink communication may communicate to use a subset of resources.

In Mode-2 resource selection, sidelink UE-s autonomously reserve resources, as there is no central entity present (like the gNB). A sidelink transmitter UE may determine its transmission resources to use for sidelink transmission to another UE, from a set of candidate resources.

In one example, to select a set of resources from a resource pool, a sidelink transmitter UE may monitor for future resource reservations by other sidelink UEs. For example, the sidelink transmitter UE may continuously decode SCI from one or more peers. The SCI may contain reservation information, e.g., resources (slots+RBs) peers will use in future.

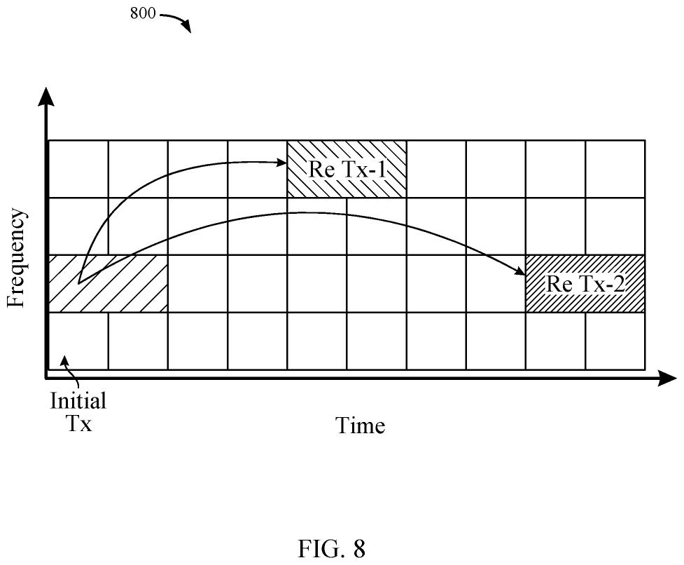

As illustrated in FIG. 8, a sidelink transmitter UE may send a SCI indicating resource reservations (from a candidate set with a resource pool) for an initial transmission, as well as future reservations for one or more retransmissions (e.g., ReTX-1 and ReTX-2).

When and if the sidelink transmitter UE acts on this information may depend on a few factors. For example, if the peer whose SCI is decoded has a high reference signal received power (RSRP), that peer is likely close to the UE and its transmissions would likely cause higher interference. Thus, the sidelink transmitter UE may remove all resources indicated in the SCI from a candidate set when selecting transmission resources.

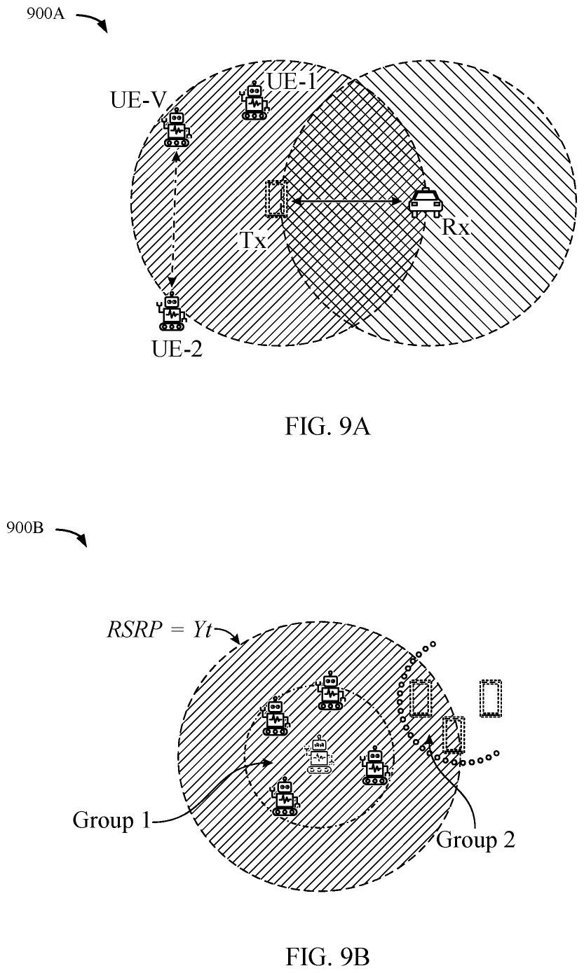

The techniques presented herein may be utilized in unicast or groupcast scenarios. For example, FIG. 9A illustrates an example of unicast transmissions sent from a transmitter UE to a single receiver UE. For unicast communications, a UE is only interested in receiving from, or transmitting to, one or few other UEs. In this case, only one second UE forwarding reservation information from a first UE may offer little or no gains to reliability.

As illustrated in FIG. 9A, at a UE-V a reservation sent by a transmitter UE may not be received (e.g., due to collision/half duplex etc.). If only a receiver UE forwards the reservation information, the reservation information may not reach the UE-V and may actually create collisions for the transmission between a UE 2 and the UE-V. According to certain aspects presented herein, however, a UE-1, although not involved in either of the unicast sessions, may help enhance reliability by forwarding future resource reservation information.

FIG. 9B illustrates an example of groupcast transmissions sent from a transmitter UE to a group of UEs (e.g., Group 1 or Group 2). The illustrated example shows relatively small group sizes. In this example, some UEs in Group 1 and Group 2 may be in each other's communication range but not in the group (for example, if a group is determined by a feedback distance threshold). In this case, reservation information sent from members in Group 1 not forwarded by members in Group 2, even though transmissions in one group may lead to collisions with transmission in the other group.

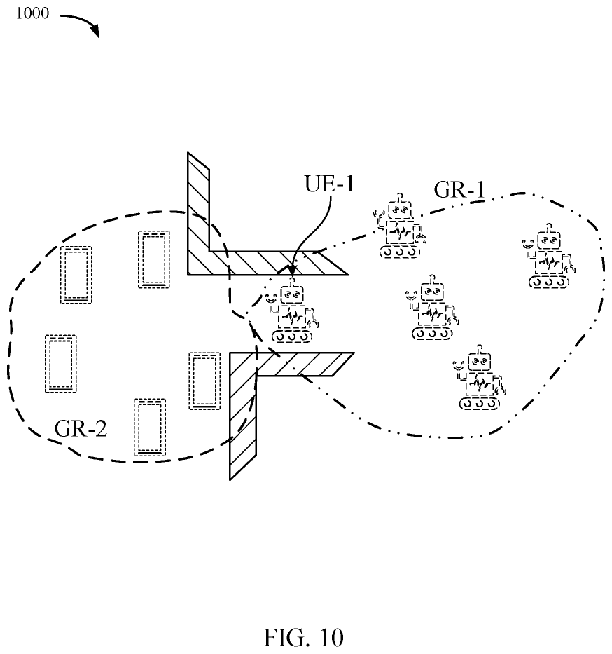

FIG. 10 illustrates another example, with non-uniform group geometry, in which aspects of the present disclosure may help enhance reliability of sidelink communications. In the illustrated example, UE-1 is in Group 1 but is also close to Group 2 UE-s (though other Group 1 members are far away). In this scenario, if UE-1 does not forward reservation information from Group-2 to Group-1, other Group 1 UEs, who cannot hear from Group 2 UEs may transmit on colliding resources, which will likely lead to high packet losses at UE-1.

### Example Inter-UE Coordination Information

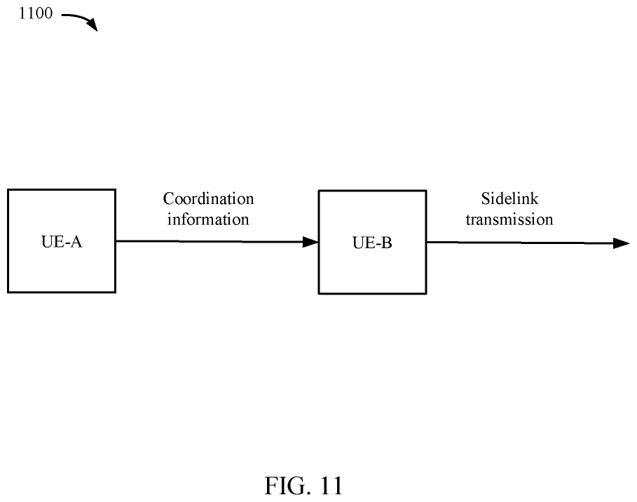

A sidelink user equipment (UE) may send coordination information (e.g., inter-UE coordination information) to another UE. As illustrated in FIG. 11, UE-A may generate and send coordination information to UE-B. In one example, the coordination information may include an indication of a preferred resource for UE-B future transmission. In another example, the coordination information may include an indication of a non-preferred resource for UE-B future transmission. In another example, the coordination information may include an indication of a resource collision. The coordination information helps UE-B better perform its resource allocation (e.g., to avoid resource collisions).

In some cases, a resource collision may refer to various scenarios in which a potential collision may occur, such as when two or more UEs transmit on same/overlapping resources (e.g., a pre-collision scenario where UE-A detects multiple reservations reserving a same/overlapped resource, and may send indication to notify one or multiple of the UEs that have made the reservations), when two or more UEs transmitting in a same slot and therefore cannot “hear” each other due to half duplex constraints (e.g., a post-collision scenario where UE-A detects collided transmissions, and may send an indication to one or multiple of the colliding UEs), and/or when two or more UEs transmitting in the same slot where leakage from one UE interferes with other UE's signal at an intended receiver (e.g., in-band emission).

The coordination information can be transmitted from one UE to another UE using different mechanisms or containers depending on a payload size. In one example, the coordination information may be transmitted from one UE to another UE using a physical sidelink feedback channel (PSFCH) (e.g., collision and/or half-duplex indication). In another example, the coordination information may be transmitted from one UE to another UE using a sidelink control information (SCI) (e.g., SCI-2 via a physical sidelink shared channel (PSSCH) by sensing information or candidate resources). In another example, the coordination information may be transmitted from one UE to another UE using a media access control (MAC) control element (CE) (e.g., via the PSSCH by sensing information or candidate resources). In another example, the coordination information may be transmitted from one UE to another UE using a new physical (PHY) channel. In another example, the coordination information may be transmitted from one UE to another UE using a radio resource control (RRC) signaling.

The coordination information may be periodically transmitted from one UE to another UE. In some cases, the coordination information may be triggered. When the coordination information is triggered, the trigger may be an event based (e.g., an occurrence of a collision) and/or a request based (e.g., a UE requesting assistance information from another UE).

A UE may support and implement various schemes for inter-UE coordination. The various schemes may include a first inter-UE coordination scheme and a second inter-UE coordination scheme.

In the first inter-UE coordination scheme, coordination information sent from UE-A to UE-B may include a set of resources preferred and/or non-preferred for UE-B transmission. In some cases, there may be a down-selection between a preferred resource set and a non-preferred resource set. In some cases, there may be additional information (e.g., other than indicating time/frequency of resources within the set) in the coordination information. In some cases, there may be some conditions that determine when the first inter-UE coordination scheme is used.

In the second inter-UE coordination scheme, coordination information sent from UE-A to UE-B may include a presence of expected/potential and/or detected resource conflict(s) on resources indicated by UE-B (e.g., via a SCI). With the second inter-UE coordination scheme, there may be a down-selection between the expected/potential conflict and the detected resource conflict. With second inter-UE coordination scheme, there may be some conditions that determine when the second inter-UE coordination scheme is used.

In some cases, a UE (such as a half-duplex UE) can either transmit or receive but cannot do both simultaneously. In such cases, the UE makes a decision about whether to receive or transmit based on a priority of a transmission. In one example, the priority may be indicated in a SCI. In another example, the priority may be obtained from higher layers.

In some cases, there may be a limit on a number of simultaneous inter-UE coordination transmissions a UE can perform to transmit coordination information to other UEs, for example, when each inter-UE coordination transmission (e.g., inter-UE coordination message) is carried in one PHY channel (e.g., a PSFCH, a physical sidelink control channel (PSCCH), or a PSSCH). In one example, when the limit is exceeded, the UE may select a subset of inter-UE coordination transmissions for sending to other UEs based on a priority, which may be obtained from received SCIs. In another example, when the limit is exceeded, the UE may select the subset of inter-UE coordination transmissions for sending to another UE based on the priority, which may be obtained from higher layers. In some cases, when a UE may use a single transmission to transmit inter-UE coordination information to other UEs (e.g., using the PSSCH), an amount of inter-UE coordination information (or a number of inter-UE coordination messages) that can be carried in the single transmission may be limited. For example, the UE may have inter-UE coordination information for multiple UEs, but each PSSCH may be able to carry inter-UE coordination information to only one UE, and the UE may be able to send only one PSSCH transmission in one slot (and thus only a limited number of PSSCH transmissions can be sent by the UE).

In some cases (e.g., new radio (NR) Release′16), sidelink communications may be performed based on a priority. For example, when there are more number of sidelink communications (i.e., transmissions or receptions) than a capability of a UE (or there is a conflict between the transmissions and the receptions), the UE may transmit/receive the sidelink communications with a higher priority.

In one example, for a PSSCH transmission, a priority is associated with a packet and is indicated in a SCI (e.g., a smaller priority value>a higher priority value). In another example, for a PSFCH transmission, a priority is same as a priority of a corresponding PSSCH transmission. In another example, for a synchronization signal block (SSB) and/or a physical sidelink broadcast channel (PSBCH) transmission, there may be a RRC configured priority. In some cases, when there are more number of transmissions (or receptions) than a capability of a UE (or there is a conflict between the transmissions and the receptions), the UE may transmit/receive the transmissions with a higher priority.

As noted above, in some cases, a UE may not be able to send all coordination information transmissions to other UEs based on a capability of the UE or other factors. In such cases, when the UE has to select a subset of coordination information transmissions from a larger pool of coordination information transmissions for sending to other UEs, the UE is not able to use priority rules defined for sidelink communications for selecting the subset of coordination information transmissions. This is because a need for coordination information for different cast types may be different (e.g., a failure in a groupcast transmission may have more significant impact than that in a unicast transmission since more UEs are involved). Also, the impact from different inter-UE coordination schemes can be different (e.g., coordination information such as a conflict indication message may be more urgent than other types of coordination information in some scenarios). Furthermore, in some cases, prioritization of the coordination information transmissions may be related to a role of helping the UE (e.g., whether the UE is in a same group/whether the UE is an intended receiver, etc.)

### Example Considerations on Prioritizing Inter-UE Coordination

Aspects of the present disclosure provide apparatuses, methods, processing systems, and computer readable mediums for prioritizing inter-user equipment (UE) coordination. For example, a UE may prioritize selection and transmission of inter-UE coordination messages based on a cast type (or a hybrid automatic repeat request (HARQ) feedback type), whether the UE is an intended receiver of another UE, and/or a type of an inter-UE coordination message.

FIG. 12 is a flow diagram illustrating example operations 1200 for wireless communication by a first UE, in accordance with certain aspects of the present disclosure. The operations 1200 may be performed, for example, by the UE 120a in the wireless communication network 100 of FIG. 1. The operations 1200 may be implemented as software components that are executed and run on one or more processors (e.g., the controller/processor 280 of FIG. 2). Further, the transmission and reception of signals by the first UE in operations 1200 may be enabled, for example, by one or more antennas (e.g., the antennas 252 of FIG. 2). In certain aspects, the transmission and/or reception of signals by the UE may be implemented via a bus interface of one or more processors (e.g., the controller/processor 280) obtaining and/or outputting signals.

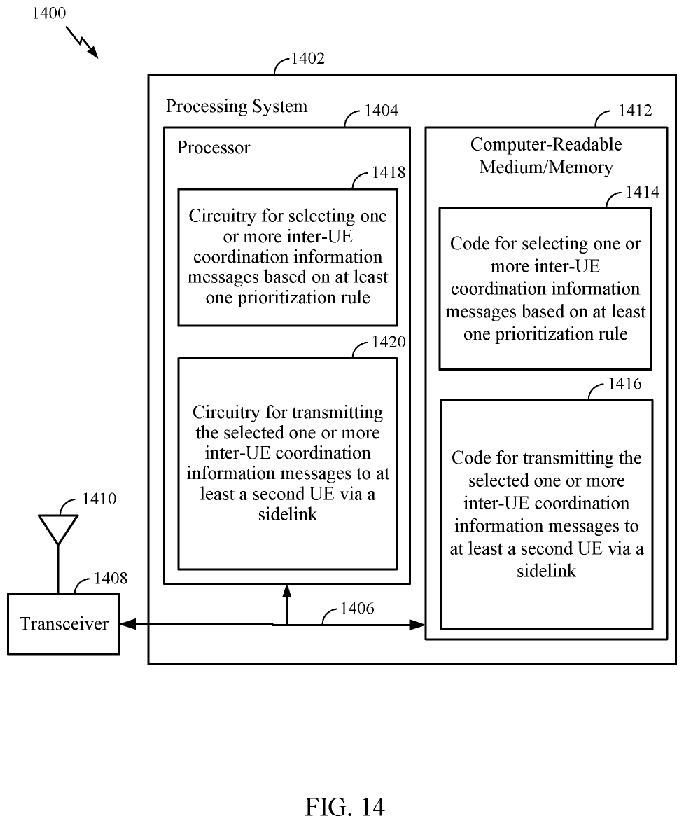

The operations 1200 begin, at 1202, by selecting one or more inter-UE coordination information messages based on at least one prioritization rule. For example, the first UE may select the one or more inter-UE coordination information messages using a processor of the UE 120a shown in FIG. 1 or FIG. 2 and/or of the apparatus shown in FIG. 14.

At 1206, the UE transmits the selected one or more inter-UE coordination information messages to at least a second UE (e.g., the UE 120b shown in FIG. 1) via a sidelink. For example, the UE may transmit the selected one or more inter-UE coordination information messages using antenna(s) and transmitter/transceiver components of the UE 120a shown in FIG. 1 or FIG. 2 and/or of the apparatus shown in FIG. 14.

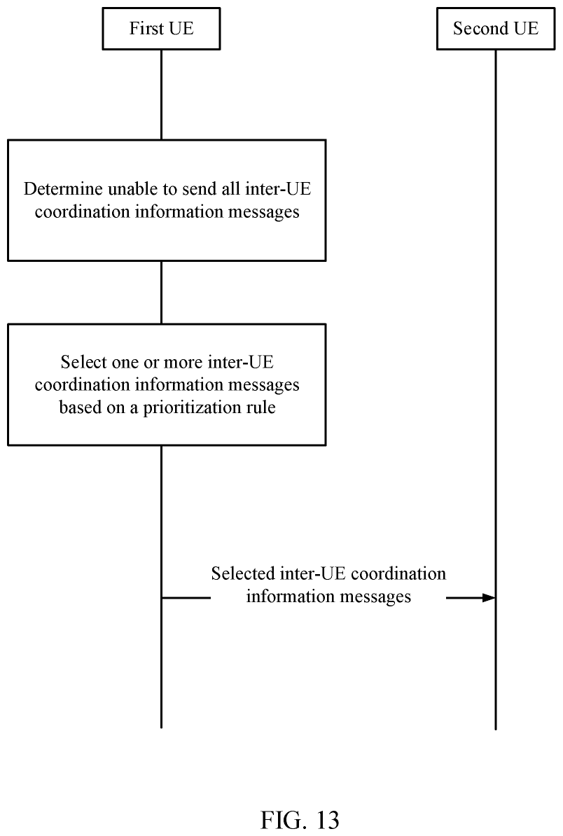

The operations shown in FIG. 12 may be understood with reference to FIG. 13.

As illustrated in FIG. 13, a first UE may determine that the first UE cannot send each of a plurality of inter-UE coordination information messages to at least a second UE based at least on a capability of the first UE. The first UE then selects one or more inter-UE coordination information messages from the plurality of inter-UE coordination information messages for sending to the second UE. The first UE selects the one or more inter-UE coordination information messages based on a prioritization rule.

In certain aspects, a prioritization rule is based on a cast type of one or more inter-UE coordination information messages. The cast type may include a unicast type, a first groupcast type, a second groupcast type, and/or a broadcast type. In certain aspects, a prioritization rule is based on a priority value of one or more inter-UE coordination information messages. In certain aspects, a prioritization rule is based on a type of a HARQ feedback (e.g., NACK only feedback, or ACK-NACK feedback). In certain aspects, a prioritization rule is based on whether a HARQ feedback is enabled. In certain aspects, a prioritization rule is based on whether a first UE is an intended receiver of a second UE. In certain aspects, a prioritization rule is based on a type of coordination indication. In certain aspects, a prioritization rule is based on a type of a conflict indication message (e.g. a post-collision conflict indication message, or a pre-collision conflict indication message). In certain aspects, a prioritization rule is based on a resource indication (e.g., a preferred resource indication, or a non-preferred resource indication).

In certain aspects, when one or more inter-UE coordination information messages indicate conflicting transmissions on overlapping resources (i.e., a post-collision conflict indication message) or conflicting reservations of overlapping resources (i.e., a pre-collision conflict indication message), a prioritization rule may initially prioritize the one or more inter-UE coordination information messages based on a cast type of the one or more inter-UE coordination information messages, and may subsequently prioritize the one or more inter-UE coordination information messages within the cast type based on assigned priority values.

In certain aspects, for the one or more inter-UE coordination information messages that indicate conflicting transmissions on overlapping resources or conflicting reservations of overlapping resources, the prioritization rule prioritizes the one or more inter-UE coordination information messages based on assigned priority values and subsequently prioritizes the one or more inter-UE coordination information messages based on a cast type (e.g., when multiple inter-UE coordination information messages have a same priority value).

In one example, when one or more inter-UE coordination information messages (such as post-collision or pre-collision conflict indication messages) are initially prioritized based on a cast type, an indication corresponding to a conflict of a transmission with a negative acknowledgement (NACK) feedback (a first groupcast type) may be prioritized over a transmission with an acknowledgement (ACK)/NACK feedback (a second groupcast type and a unicast type). This is because for a transmission with the NACK feedback, if all receiver UEs cannot decode this transmission (even via a physical sidelink control channel (PSCCH)), the receiver UEs will not be able to send a NACK (i.e., no HARQ feedback), and a transmitter UE will not know if this was because no receiver UEs were able to decode the transmission or because all relevant UEs decoded the transmission.

In another example, when one or more inter-UE coordination information messages (such as post-collision or pre-collision conflict indication messages) are initially prioritized based on a cast type, for a transmission that may carry a disabled feedback (e.g., a broadcast type), a conflict indication message to a corresponding transmitter UE may be de-prioritized.

In another example, after one or more inter-UE coordination information messages (such as post-collision or pre-collision conflict indication messages) are prioritized based on a cast type, within each cast type (e.g., a first groupcast type with a NACK-only feedback transmission), the conflict indication messages may be further prioritized based on a priority of each conflict indication message (i.e., when a UE has to transmit more conflict indication messages than a capability of the UE, the UE first prioritizes the conflict indication messages based on the cast type, and then prioritize based on a priority of the conflict indication message within the cast type).

In certain aspects, when a first UE has to transmit more inter-UE coordination information messages (that indicate preferred resources or non-preferred resources for transmissions by a second UE) than the first UE can handle (i.e., the first UE has to transmit more than one resource preference indication message in a same slot), the first UE may prioritize the inter-UE coordination information messages based on a cast type, and subsequently prioritize the inter-UE coordination information messages within the cast type based on assigned priority values.

In certain aspects, when a first UE has to transmit more inter-UE coordination information messages (that indicate preferred resources or non-preferred resources for transmissions by a second UE) than the first UE can handle (i.e., the first UE has to transmit more than one resource preference indication message in a same slot), the first UE may prioritize the inter-UE coordination information messages based on assigned priority values and subsequently prioritizes the inter-UE coordination information messages based on a cast type.

In one example, when one or more inter-UE coordination information messages (such as resource preference indication messages) are prioritized based on a cast type, a prioritization rule may prioritize transmission of the resource preference indication messages of a broadcast type over the resource preference indication messages of a groupcast type, and may subsequently prioritize the transmission of the resource preference indication messages of the groupcast type over the resource preference indication messages of a unicast type. Furthermore, the resource preference indication messages of a first groupcast type may have a higher priority than the resource preference indication messages of a second groupcast type. In some cases, the resource preference indication messages of the unicast type may have less priority than others because a failure of decoding of other cast types (such as a broadcast or a groupcast type) may have impact on more number of UEs.

In certain aspects, a prioritization rule may be based on whether a first UE is an intended receiver of a second UE. In one example, the first UE may determine the first UE to be the intended receiver of the second UE when the first UE and the second UE are communicating in a unicast communication mode. In another example, the first UE may determine the first UE to be the intended receiver of the second UE when the first UE and the second UE are in a same group (e.g., the first UE and the second UE are in the same group when the first UE and the second UE share a same group ID or layer-1 or layer-2 destination ID). In another example, the first UE may determine the first UE to be the intended receiver of the second UE when the first UE is within a communication range indicated by the second UE.

In certain aspects, a prioritization rule may prioritize one or more inter-UE coordination information messages based on whether a first UE is an intended receiver of a second UE, and may subsequently prioritize the one or more inter-UE coordination information messages based on assigned priority values.

In certain aspects, a prioritization rule may prioritize one or more inter-UE coordination information messages based on assigned priority values, and may subsequently prioritize the one or more inter-UE coordination information messages based on whether a first UE is an intended receiver of a second UE (e.g., when multiple inter-UE coordination information messages have a same priority value).

In certain aspects, a prioritization rule may be based on a type of one or more inter-UE coordination information messages. In one example, the prioritization rule may prioritize one or more inter-UE coordination information messages based on the type of the one or more inter-UE coordination information messages, and may subsequently prioritize the one or more inter-UE coordination information messages based on assigned priority values. In another example, the prioritization rule may prioritize the one or more inter-UE coordination information messages based on the assigned priority values, and may subsequently prioritize the one or more inter-UE coordination information messages based on the type of the one or more inter-UE coordination information messages.

In certain aspects, a prioritization rule may be based on whether one or more inter-UE coordination information messages indicate conflicting transmissions on overlapping resources (i.e., post-collision conflict indication messages) or conflicting reservations of overlapping resources (i.e., pre-collision conflict indication messages).

In one example, when a first UE is not able to send both post-collision conflict indication messages and pre-collision conflict indication messages to a second UE, a prioritization rule may prioritize transmission of the post-collision conflict indication messages over the pre-collision conflict indication messages. This is because the post-collision conflict indication messages are for conflicts that already happened, and there is more urgent need to indicate these conflicts to the second UE so that the second UE can act accordingly to deliver its packet within a packet delay budget (PDB).

In certain aspects, a prioritization rule may be based on whether one or more inter-UE coordination information messages indicate preferred resources or non-preferred resources for transmissions by a second UE.

In one example, a prioritization rule may prioritize transmission of one or more inter-UE coordination information messages indicating non-preferred resources over the one or more inter-UE coordination information messages indicating preferred resources. The one or more inter-UE coordination information messages indicating the non-preferred resources may be prioritized because transmitting on these non-preferred resources by a second UE may impact receipt of other interested transmissions by a first UE.

In another example, a prioritization rule may prioritize transmission of one or more inter-UE coordination information messages indicating preferred resources over the one or more inter-UE coordination information messages indicating non-preferred resources, when a second UE does not have a sidelink sensing capability (i.e., the second UE is unable to identify available resources by itself, and the second UE relies on an indication from a first UE).

In certain aspects, a prioritization rule may prioritize transmission of one or more inter-UE coordination information messages that indicate conflicting transmissions on overlapping resources (i.e., post-collision conflict indication messages) or conflicting reservations of overlapping resources (i.e., pre-collision conflict indication messages) over the one or more inter-UE coordination information messages that indicate preferred resources or non-preferred resources for the transmissions by a second UE. This is because the post-collision conflict indication messages and the pre-collision conflict indication messages are more urgent since the conflict has already happened or about to happen.

In certain aspects, a first UE may jointly implement multiple prioritization rules to select one or more inter-UE coordination information messages. The first UE then sends the selected one or more inter-UE coordination information messages to a second UE.

In one example, when a first UE implements multiple prioritization rules to select one or more inter-UE coordination information messages, the first UE may implement a first prioritization rule (which is based on whether the first UE is an intended receiver of a second UE) and then implement a second prioritization rule (which is based on a cast type of the one or more inter-UE coordination information messages). In another example, the first UE may implement a third prioritization rule (which is based on assigned priority values of the one or more inter-UE coordination information messages), followed by the first prioritization rule, and then the second prioritization rule to select the one or more inter-UE coordination information messages. In another example, the first UE may implement the first prioritization rule, followed by the second prioritization rule, and then the third prioritization rule to select the one or more inter-UE coordination information messages. The first UE then sends the selected one or more inter-UE coordination information messages to the second UE.

### Example Wireless Communication Device

FIG. 14 illustrates a communications device 1400 that may include various components (e.g., corresponding to means-plus-function components) configured to perform operations for the techniques disclosed herein, such as the operations illustrated in FIG. 12. The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 is configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., a computer-executable code) that when executed by the processor 1404, cause the processor 1404 to perform the operations illustrated in FIG. 12, or other operations for performing the various techniques discussed herein. In certain aspects, computer-readable medium/memory 1412 stores code 1414 for selecting and code 1416 for transmitting. The code 1414 for selecting may include code for selecting one or more inter-user equipment (UE) coordination information messages based on at least one prioritization rule. The code 1416 for transmitting may include code for transmitting the selected one or more inter-UE coordination information messages to at least a second UE via a sidelink.

The processor 1404 may include circuitry configured to implement the code stored in the computer-readable medium/memory 1412, such as for performing the operations illustrated in FIG. 12, as well as other operations for performing the various techniques discussed herein. For example, the processor 1404 includes circuitry 1418 for selecting and circuitry 1420 for transmitting. The circuitry 1418 for selecting may include circuitry for selecting one or more inter-UE coordination information messages based on at least one prioritization rule. The circuitry 1420 for transmitting may include circuitry for transmitting the selected one or more inter-UE coordination information messages to at least a second UE via a sidelink.

### Example Aspects

Implementation examples are described in the following numbered aspects.

In a first aspect, a method for wireless communications by a first user equipment (UE), comprising: selecting one or more inter-UE coordination information messages based on at least one prioritization rule; and transmitting the selected one or more inter-UE coordination information messages to at least a second UE via a sidelink.

In a second aspect, alone or in combination with the first aspect, the prioritization rule is based on at least one of: a cast type of the one or more inter-UE coordination information messages; or a priority value of the one or more inter-UE coordination information messages.

In a third aspect, alone or in combination with one or more of the first and second aspects, the cast type comprises one of a unicast type, a first groupcast type, a second groupcast type, or a broadcast type.

In a fourth aspect, alone or in combination with one or more of the first through third aspects, for the one or more inter-UE coordination information messages that indicate conflicting transmissions on overlapping resources or conflicting reservations of the overlapping resources, the prioritization rule prioritizes the one or more inter-UE coordination information messages based on a cast type of the one or more inter-UE coordination information messages; and subsequently prioritizes the one or more inter-UE coordination information messages within the cast type based on assigned priority values.

In a fifth aspect, alone or in combination with one or more of the first through fourth aspects, for the one or more inter-UE coordination information messages that indicate conflicting transmissions on overlapping resources or conflicting reservations of the overlapping resources, the prioritization rule prioritizes the one or more inter-UE coordination information messages based on assigned priority values; and subsequently prioritizes the one or more inter-UE coordination information messages based on a cast type, when multiple inter-UE coordination information messages have a same priority value.

In a sixth aspect, alone or in combination with one or more of the first through fifth aspects, for the one or more inter-UE coordination information messages that indicate preferred resources or non-preferred resources for transmissions by the second UE, the prioritization rule prioritizes transmission of the one or more inter-UE coordination information messages of a broadcast type over the one or more inter-UE coordination information messages of a groupcast type, and subsequently prioritizes the transmission of the one or more inter-UE coordination information messages of the groupcast type over the one or more inter-UE coordination information messages of a unicast type.

In a seventh aspect, alone or in combination with one or more of the first through sixth aspects, the prioritization rule is based on whether the first UE is an intended receiver of the second UE.

In an eighth aspect, alone or in combination with one or more of the first through seventh aspects, determining the first UE to be the intended receiver of the second UE when at least one of: the first UE and the second UE are communicating in a unicast communication mode; the first UE and the second UE are in a same group; or the first UE is within a communication range indicated by the second UE.

In a ninth aspect, alone or in combination with one or more of the first through eighth aspects, the prioritization rule prioritizes the one or more inter-UE coordination information messages based on whether the first UE is the intended receiver of the second UE, and subsequently prioritizes the one or more inter-UE coordination information messages based on assigned priority values.

In a tenth aspect, alone or in combination with one or more of the first through ninth aspects, the prioritization rule prioritizes the one or more inter-UE coordination information messages based on assigned priority values, and subsequently prioritizes the one or more inter-UE coordination information messages based on whether the first UE is the intended receiver of the second UE, when multiple inter-UE coordination information messages have a same priority value.

In an eleventh aspect, alone or in combination with one or more of the first through tenth aspects, the prioritization rule is based on at least one of: whether the one or more inter-UE coordination information messages indicate conflicting transmissions on overlapping resources or conflicting reservations of the overlapping resources; or whether the one or more inter-UE coordination information messages indicate preferred resources or non-preferred resources for transmissions by the second UE.

In a twelfth aspect, alone or in combination with one or more of the first through eleventh aspects, the prioritization rule prioritizes transmission of the one or more inter-UE coordination information messages indicating the conflicting transmissions on the overlapping resources over the one or more inter-UE coordination information messages indicating the conflicting reservations of the overlapping resources.

In a thirteenth aspect, alone or in combination with one or more of the first through twelfth aspects, the prioritization rule prioritizes transmission of the one or more inter-UE coordination information messages indicating the non-preferred resources over the one or more inter-UE coordination information messages indicating the preferred resources.

In a fourteenth aspect, alone or in combination with one or more of the first through thirteenth aspects, the prioritization rule prioritizes transmission of the one or more inter-UE coordination information messages indicating the preferred resources over the one or more inter-UE coordination information messages indicating the non-preferred resources, when the second UE does not have a sidelink sensing capability.

In a fifteenth aspect, alone or in combination with one or more of the first to fourteenth aspects, the prioritization rule prioritizes transmission of the one or more inter-UE coordination information messages that indicate the conflicting transmissions on the overlapping resources or the conflicting reservations of the overlapping resources over the one or more inter-UE coordination information messages that indicate the preferred resources or the non-preferred resources for the transmissions by the second UE.

In a sixteenth aspect, alone or in combination with one or more of the first to fifteenth aspects, the one or more inter-UE coordination information messages are selected based on multiple prioritization rules that are applied jointly.

An apparatus for wireless communication, comprising at least one processor; and a memory coupled to the at least one processor, the memory comprising code executable by the at least one processor to cause the apparatus to perform the method of any of the first through sixteenth aspects.

An apparatus comprising means for performing the method of any of the first through sixteenth aspects.

A computer readable medium storing computer executable code thereon for wireless communications that, when executed by at least one processor, cause an apparatus to perform the method of any of the first through sixteenth aspects.

### Additional Considerations

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, allocating, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (UE) 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 12.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a first user equipment (UE), comprising:
selecting one or more inter-UE coordination information messages based on at least one prioritization rule; and
transmitting the selected one or more inter-UE coordination information messages to at least a second UE via a sidelink.

2. The method of claim 1, wherein the prioritization rule is based on at least one of:
a cast type of the one or more inter-UE coordination information messages; or
a priority value of the one or more inter-UE coordination information messages.

3. The method of claim 2, wherein the cast type comprises one of a unicast type, a first groupcast type, a second groupcast type, or a broadcast type.

4. The method of claim 1, wherein, for the one or more inter-UE coordination information messages that indicate conflicting transmissions on overlapping resources or conflicting reservations of overlapping resources, the prioritization rule
prioritizes the one or more inter-UE coordination information messages based on a cast type of the one or more inter-UE coordination information messages; and
subsequently prioritizes the one or more inter-UE coordination information messages within the cast type based on assigned priority values.

5. The method of claim 1, wherein, for the one or more inter-UE coordination information messages that indicate conflicting transmissions on overlapping resources or conflicting reservations of overlapping resources, the prioritization rule
prioritizes the one or more inter-UE coordination information messages based on assigned priority values; and
subsequently prioritizes the one or more inter-UE coordination information messages based on a cast type, when multiple inter-UE coordination information messages have a same priority value.

6. The method of claim 1, wherein, for the one or more inter-UE coordination information messages that indicate preferred resources or non-preferred resources for transmissions by the second UE, the prioritization rule
prioritizes transmission of the one or more inter-UE coordination information messages of a broadcast type over the one or more inter-UE coordination information messages of a groupcast type, and
subsequently prioritizes the transmission of the one or more inter-UE coordination information messages of the groupcast type over the one or more inter-UE coordination information messages of a unicast type.

7. The method of claim 1, wherein the prioritization rule is based on whether the first UE is an intended receiver of the second UE.

8. The method of claim 7, further comprising determining the first UE to be the intended receiver of the second UE when at least one of:
the first UE and the second UE are communicating in a unicast communication mode;
the first UE and the second UE are in a same group; or
the first UE is within a communication range indicated by the second UE.

9. The method of claim 7, wherein the prioritization rule
prioritizes the one or more inter-UE coordination information messages based on whether the first UE is the intended receiver of the second UE, and
subsequently prioritizes the one or more inter-UE coordination information messages based on assigned priority values.

10. The method of claim 7, wherein the prioritization rule
prioritizes the one or more inter-UE coordination information messages based on assigned priority values, and
subsequently prioritizes the one or more inter-UE coordination information messages based on whether the first UE is the intended receiver of the second UE, when multiple inter-UE coordination information messages have a same priority value.

11. The method of claim 1, wherein the prioritization rule is based on at least one of:
whether the one or more inter-UE coordination information messages indicate conflicting transmissions on overlapping resources or conflicting reservations of overlapping resources; or
whether the one or more inter-UE coordination information messages indicate preferred resources or non-preferred resources for transmissions by the second UE.

12. The method of claim 11, wherein the prioritization rule prioritizes transmission of the one or more inter-UE coordination information messages indicating the conflicting transmissions on the overlapping resources over the one or more inter-UE coordination information messages indicating the conflicting reservations of the overlapping resources.

13. The method of claim 11, wherein the prioritization rule prioritizes transmission of the one or more inter-UE coordination information messages indicating the non-preferred resources over the one or more inter-UE coordination information messages indicating the preferred resources.

14. The method of claim 11, wherein the prioritization rule prioritizes transmission of the one or more inter-UE coordination information messages indicating the preferred resources over the one or more inter-UE coordination information messages indicating the non-preferred resources, when the second UE does not have a sidelink sensing capability.

15. The method of claim 11, wherein the prioritization rule prioritizes transmission of the one or more inter-UE coordination information messages that indicate the conflicting transmissions on the overlapping resources or the conflicting reservations of the overlapping resources over the one or more inter-UE coordination information messages that indicate the preferred resources or the non-preferred resources for the transmissions by the second UE.

16. The method of claim 1, wherein the one or more inter-UE coordination information messages are selected based on multiple prioritization rules that are applied jointly.

17. An apparatus for wireless communications by a first user equipment (UE), comprising:
at least one processor and a memory configured to:
select one or more inter-UE coordination information messages based on at least one prioritization rule; and
transmit the selected one or more inter-UE coordination information messages to at least a second UE via a sidelink.

18. The apparatus of claim 17, wherein the prioritization rule is based on at least one of:
a cast type of the one or more inter-UE coordination information messages; or
a priority value of the one or more inter-UE coordination information messages.

19. The apparatus of claim 18, wherein the cast type comprises one of a unicast type, a first groupcast type, a second groupcast type, or a broadcast type.

20. The apparatus of claim 17, wherein, for the one or more inter-UE coordination information messages that indicate conflicting transmissions on overlapping resources or conflicting reservations of overlapping resources, the prioritization rule
prioritizes the one or more inter-UE coordination information messages based on a cast type of the one or more inter-UE coordination information messages; and
subsequently prioritizes the one or more inter-UE coordination information messages within the cast type based on assigned priority values.

21. The apparatus of claim 17, wherein, for the one or more inter-UE coordination information messages that indicate conflicting transmissions on overlapping resources or conflicting reservations of overlapping resources, the prioritization rule
prioritizes the one or more inter-UE coordination information messages based on assigned priority values; and
subsequently prioritizes the one or more inter-UE coordination information messages based on a cast type, when multiple inter-UE coordination information messages have a same priority value.

22. The apparatus of claim 17, wherein, for the one or more inter-UE coordination information messages that indicate preferred resources or non-preferred resources for transmissions by the second UE, the prioritization rule
prioritizes transmission of the one or more inter-UE coordination information messages of a broadcast type over the one or more inter-UE coordination information messages of a groupcast type, and
subsequently prioritizes the transmission of the one or more inter-UE coordination information messages of the groupcast type over the one or more inter-UE coordination information messages of a unicast type.

23. The apparatus of claim 17, wherein the prioritization rule is based on whether the first UE is an intended receiver of the second UE.

24. The apparatus of claim 23, wherein the at least one processor and the memory is configured to determine the first UE to be the intended receiver of the second UE when at least one of:
the first UE and the second UE are communicating in a unicast communication mode;
the first UE and the second UE are in a same group; or
the first UE is within a communication range indicated by the second UE.

25. The apparatus of claim 23, wherein the prioritization rule
prioritizes the one or more inter-UE coordination information messages based on whether the first UE is the intended receiver of the second UE, and
subsequently prioritizes the one or more inter-UE coordination information messages based on assigned priority values.

26. The apparatus of claim 23, wherein the prioritization rule
prioritizes the one or more inter-UE coordination information messages based on assigned priority values, and
subsequently prioritizes the one or more inter-UE coordination information messages based on whether the first UE is the intended receiver of the second UE, when multiple inter-UE coordination information messages have a same priority value.

27. The apparatus of claim 17, wherein the prioritization rule is based on at least one of:
whether the one or more inter-UE coordination information messages indicate conflicting transmissions on overlapping resources or conflicting reservations of overlapping resources; or
whether the one or more inter-UE coordination information messages indicate preferred resources or non-preferred resources for transmissions by the second UE.

28. The apparatus of claim 27, wherein the prioritization rule prioritizes at least one of:
transmission of the one or more inter-UE coordination information messages indicating the conflicting transmissions on the overlapping resources over the one or more inter-UE coordination information messages indicating the conflicting reservations of the overlapping resources;
transmission of the one or more inter-UE coordination information messages indicating the non-preferred resources over the one or more inter-UE coordination information messages indicating the preferred resources; or
transmission of the one or more inter-UE coordination information messages indicating the preferred resources over the one or more inter-UE coordination information messages indicating the non-preferred resources, when the second UE does not have a sidelink sensing capability.

29. The apparatus of claim 27, wherein the prioritization rule prioritizes transmission of the one or more inter-UE coordination information messages that indicate the conflicting transmissions on the overlapping resources or the conflicting reservations of the overlapping resources over the one or more inter-UE coordination information messages that indicate the preferred resources or the non-preferred resources for the transmissions by the second UE.

30. The apparatus of claim 17, wherein the one or more inter-UE coordination information messages are selected based on multiple prioritization rules that are applied jointly.
